(19) United States
(12) Patent Application Publication
(10) Pub. No.: US 2025/0070166 A1
(43) Pub. Date: Feb. 27, 2025

(54) CATHODE MATERIAL, PREPARATION METHOD THEREFOR AND USE THEREOF

(71) Applicant: ZHEJIANG JINKO ENERGY STORAGE CO., LTD., Haining City (CN)

(72) Inventors: Longhui LIAO, Haining City (CN); Zixiang YANG, Haining City (CN)

(73) Assignee: ZHEJIANG JINKO ENERGY STORAGE CO., LTD., Haining City (CN)

(21) Appl. No.: 18/943,445

(22) Filed: Nov. 11, 2024

(30) Foreign Application Priority Data
Sep. 27, 2024 (CN) 202411364641.5

(51) Int. Cl. H01M 4/58; H01M 4/02; H01M 4/04; H01M 4/36; H01M 4/583; H01M 10/0569

(52) U.S. Cl. CPC H01M 4/5825; H01M 4/0471; H01M 4/366; H01M 4/583; H01M 10/0569; H01M 2004/028

(57) ABSTRACT

A Cathode material and a preparation method therefor and use thereof are provided. The cathode material includes a cathode active substrate, and a surface of the cathode active substrate is coated with a carbon coating layer, wherein a surface of the carbon coating layer has an esterophilic group. The invention changes the surface energy of the carbon coating layer by introducing the esterophilic carbonyl to the surface of the carbon coating layer of the cathode active substrate, thereby significantly improving the wettability of the cathode active particles to the electrolyte. Moreover, the bulk structure of the active material is not changed, so the electrochemical performance of the cathode active material is guaranteed. The cathode plate prepared by the invention shows excellent wettability in the electrolyte, and a prepared battery shows low internal resistance, high energy efficiency and other characteristics.

### CROSS-REFERENCE TO RELATED APPLICATIONS

This application claims priority to Chinese Patent Application No. 202411364641.5, filed with the China National Intellectual Property Administration on Sep. 27, 2024, the entire disclosure of which is incorporated herein by reference.

### FIELD

The present disclosure relates to the technical field of energy storage materials and, in particular, to a cathode material and a preparation method therefor and use thereof.

### BACKGROUND

The statements in this section merely provide background information related to the present disclosure and may not constitute prior art.

For lithium-ion batteries, materials, structural design and manufacturing level all affect their performance. The wetting of the electrode plates for lithium-ion batteries is an issue that cannot be ignored in the design and manufacturing process of lithium batteries. Whether electrode plates are wetted or not will directly determines the performance of electrode active materials. Electrode plates with low wettability often show high internal resistance, resulting in loss of energy efficiency and capacity of battery cells. Therefore, ensuring sufficient wetting of electrode plates of the batteries has a significant effect in improving the performance of lithium batteries. In order to ensure sufficient wetting of electrode plates of the batteries, in addition to extending the wetting time during the manufacturing process, it is more often to improve the wettability of the electrode plates in electrolyte from the perspective of battery materials. Currently, the focus is mainly on the designs of separators and electrode plates.

The separator is an important material to ensure the wettability of an electrode plate. The porosity of the separator and its wettability in electrolyte will affect its liquid absorption. At present, the wettability of the separator is mainly improved by improving the porosity of the separator through the design of separator structure, or the wettability to the electrolyte is improved by performing the surface modification on the separator, so as to achieve the purpose of improving the liquid absorption speed and liquid absorption capacity of the separator.

In addition, the diffusion of lithium ions in the material is also improved through the design of the electrode structure, that is, to improve the filling rate of the electrolyte in the electrode plate. The diffusion rate of lithium ions in the electrode is mainly ensured by designing a multilayer structure with different porosities. For example, a layer of coating with lower porosity is first applied to a side close to a current collector, and then another layer of coating with high porosity is applied to its surface. In this way, the energy density of the obtained electrode plate is ensured and the diffusion of lithium ions in the electrode plate is also improved.

Although the methods of improving the wettability of the electrode plate by the designs of the separator and the electrode structure can achieve good results, these strategies are all passive ways to improve the wetting effect of the electrode material. When the electrolyte is consumed to a certain extent as the cycle number of the battery increases, these methods cannot achieve a good wetting effect. In this case, although the pores of the separator are filled with a certain amount of electrolyte, it is not enough to well wet the electrode plate.

### SUMMARY

This section provides a general summary of the disclosure and is not a comprehensive disclosure of its full scope or all of its features.

A main objective of the present invention is to provide a cathode material and a preparation method therefor and use thereof, so as to solve the problem of poor wettability of an electrode plate of a battery in the prior art.

In order to achieve the above objective, according to an aspect of the present invention, provided is a cathode material, including a cathode active substrate, a surface of the cathode active substrate being coated with a carbon coating layer. A surface of the carbon coating layer has an esterophilic group.

Further, the esterophilic group is a C2-C8 carbonyl-containing group.

Further, the esterophilic group has a structural formula represented by:

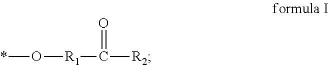

wherein, in formula I, R₁ is a C1-C4 alkylene, and R₂ is a C1-C4 alkyl or amino.

The “*” in formula I of the present invention is a chemical group linking position.

Further, R₁ is a methylene or ethylene, and/or R₂ is a methyl, ethyl or amino.

Further, the esterophilic group is chemically bonded to the surface of the carbon coating layer in the form of a covalent bond.

Further, the percentage of the esterophilic group, by weight, in the carbon coating layer is 1% to 2.5%.

Further, the weight of the carbon coating layer is 1% to 2% of weight of the cathode active substrate.

Further, the cathode active substrate includes a lithium iron phosphate, lithium manganese iron phosphate, lithium nickel iron phosphate, nickel cobalt manganese or nickel cobalt aluminum material.

According to another aspect of the present invention, provided is a method for preparing the described cathode material, including the following steps: step S1 of obtaining a cathode active substrate; step S2 of modifying the cathode active substrate by carbon coating to obtain a carbon-coated cathode active substrate; and step S3 of performing surface modification on the carbon-coated cathode active substrate, and introducing an esterophilic group to the surface of the carbon coating layer to form the cathode material.

Further, the esterophilic group in step S3 is derived from carbonyl in a haloketone or carbonyl in a haloamide.

Further, the process of performing surface modification on the carbon-coated cathode active substrate in step S3 includes: step S3-1 of obtaining a surface-hydroxylated carbon-coated cathode active substrate; step S3-2 of mixing the surface-hydroxylated carbon-coated cathode active substrate, an alkali substance and a solvent in an inert atmosphere and allowing reaction with heating to obtain an intermediate; and step S3-3 of mixing the intermediate and a compound containing an esterophilic group in an inert atmosphere and allowing reaction with heating to obtain a carbon-covered cathode active substrate with the esterophilic group on the surface, i.e., the cathode material. The compound containing the esterophilic group is a haloketone or a haloamide. The haloketone has a structure represented by formula II:

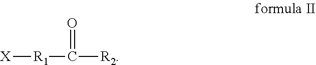

In formula II, R₁ is a C1-C4 alkylene, X is a halogen atom, and R₂ is a C1-C4 alkyl. Further, R₁ is a methylene or an ethylene, and/or R₂ is a methyl or an ethyl.

The haloamide has a structure represented by formula III:

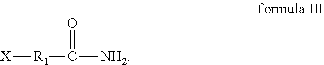

In formula III, R₁ is a C1-C4 alkylene and X is a halogen atom. Further, R₁ is a methylene or an ethylene.

Further, in step S3-2, the alkali substance includes one or more of sodium hydride, potassium hydride, lithium diisopropylamide and lithium bis(trimethylsilyl)amide.

Further, the solvent includes N,N-dimethylformamide.

Further, the inert atmosphere includes argon atmosphere.

Further, a weight ratio of the alkali substance to the surface-hydroxylated carbon-coated cathode active substrate is (0.05-0.2):1.

Further, the weight ratio of the alkali substance to the surface-hydroxylated carbon-coated cathode active substrate is (0.1-0.2):1.

Further, the reaction with heating in step S3-2 is performed at a temperature of 30-50° C. for 3.5-4.5 h.

Further, in step S3-3, the haloketone is selected from one or more of chloroacetone, chlorobutanone, bromoacetone, bromobutanone, and iodoacetone.

Further, in step S3-3, the haloketone is selected from chloroacetone, chlorobutanone, or bromoacetone.

Further, in step S3-3, the haloamide is selected from at least one of chloroacetamide, 3-chloropropionamide, and chlorobutyramide.

Further, in step S3-3, the haloamide is selected from chloroacetamide or 3-chloropropionamide.

Further, a weight ratio of the alkali substance, the surface-hydroxylated carbon-coated cathode active substrate, and the compound containing the esterophilic group is (0.05-0.2):1:(0.4-0.6).

Further, the weight ratio of the alkali substance, the surface-hydroxylated carbon-coated cathode active substrate, and the compound containing the esterophilic group is (0.1-0.2):1:(0.4-0.6).

Further, the reaction with heating in step S3-3 is performed at a temperature of 55° C.-65° C. for 10-18 h.

Further, in step S3-3, the product obtained after the reaction with heating is cooled to 20° C.-35° C. and aged for 1-2 h to obtain a crude product, and the crude product is then filtered, washed with water and spray granulated in turn to obtain the carbon-coated cathode active substrate with the esterophilic group on the surface, i.e., the cathode material.

Further, in step S3-1, the process of preparing the surface-hydroxylated carbon-coated cathode active substrate includes: mixing the carbon-coated cathode active substrate with an alkali solution, and allowing reaction with heating to obtain the surface-hydroxylated carbon-coated cathode active substrate.

Further, a ratio of the carbon-coated cathode active substrate to the alkali solution is (20-30) g:100 mL, and the concentration of the alkali solution is 1.5-2.5 mol/L.

Further, the alkali solution is selected from one or more of sodium hydroxide solution, potassium hydroxide solution, and lithium hydroxide solution.

Further, the reaction with heating in step S3-1 is performed at a temperature of 180° C.-220° C. for 5.5-6.5 h.

Further, in step S1, the cathode active substrate includes lithium iron phosphate, lithium manganese iron phosphate, lithium nickel iron phosphate, nickel-cobalt manganese, or nickel-cobalt aluminum.

Further, in step S2, a carbon source for carbon coating modification includes one or more of glucose, sucrose, citric acid, polystyrene and a biomass material.

Further, in step S2, the process of modifying the cathode active substrate by carbon coating includes: mixing the cathode active substrate and the carbon source and performing calcination in an inert atmosphere to obtain the carbon-coated cathode active substrate.

Further, a weight ratio of the cathode active substrate to the carbon source is 1:(1-1.2).

Further, the inert atmosphere includes argon atmosphere.

Further, the calcination is performed at a temperature of 550° C.-650° C. for 5.5-6.5 h.

According to a third aspect of the present invention, provided is a cathode plate, including a foil and a cathode slurry applied to a surface of the foil, wherein the cathode slurry includes a cathode material, and the cathode material is the described cathode material or the cathode material prepared by the method described above.

According to a fourth aspect of the present invention, provided is a battery, including a cathode plate, an anode plate, a separator and an electrolyte, wherein the cathode plate is the described cathode plate.

Further, the electrolyte includes an ester solvent, which is further a carbonate solvent, and more particularly one or more of dimethyl carbonate, vinyl carbonate, methyl ethyl carbonate, and diethyl carbonate.

Based on the technical solutions of the present invention, provided is a battery cathode material. At the same time of carbon coating on lithium iron phosphate, the surface energy of the carbon coating layer is changed by introducing the esterophilic carbonyl, thereby significantly improving the wettability of the cathode active particles to the electrolyte. Moreover, the method does not change the bulk structure of the active material, so the electrochemical performance of the cathode active material is guaranteed. The cathode plate prepared by the present invention shows excellent wettability in the electrolyte, and the prepared battery shows low internal resistance, high energy efficiency and other characteristics.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The drawings of the specification, forming part of the present application, are used to provide further understanding of the invention, and illustrative embodiments of the invention and their descriptions are used to explain the invention and do not constitute undue qualification of the invention. In the drawings:

FIG. 1 shows the liquid absorption curves of cathode materials prepared with different strong alkali ratios in examples of the present invention;

FIG. 2 shows the liquid absorption curves of cathode materials prepared by using different halides in examples of the present invention;

FIG. 3 shows test results of charging and discharging energy efficiency of cells in examples and comparative examples of the present invention;

FIG. 4 shows test results of DCR internal resistance in a charging process in examples and comparative examples of the present invention; and

FIG. 5 shows test results of DCR internal resistance in a discharging process in examples and comparative examples of the present invention.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It should be noted that the embodiments in the present application and the features in the embodiments may be combined with each other, provided that there is no conflict. The invention is described in detail below with reference to the accompanying drawings and in conjunction with embodiments.

In order to improve the wettability of a cathode plate of a battery in an electrolyte, the present invention improves the structure of a cathode material. The cathode material includes a cathode active substrate, and a surface of the cathode active substrate is coated with a carbon coating layer, wherein a surface of the carbon coating layer has an esterophilic group.

The estrophilic group refers to a group with close polarity and strong affinity to an ester solvent.

Considering the molecular structure of the cathode active material, by connecting the esterophilic group to the surface of the carbon coating material, the present invention greatly changes the surface energy of the carbon coating layer, effectively improves the wettability of the cathode active substrate itself in an ester electrolyte, reduces the internal resistance and cycle diving risk of the battery, and also ensures that the cathode active substrate itself has good electrochemical performance and improves the active adsorption and wettability of the cathode active material itself to the electrolyte. As a result, the issue about the wettability of the battery cathode in the electrolyte is fundamentally solved.

Studies were conducted in the present invention from the perspective of polarity of an ester electrolyte solvent, and it is found that when the esterophilic group introduced to the carbon coating layer of the cathode material is carbonyl, better wettability can be achieved between the cathode active material and an ester electrolyte solvent. For example, when the esterophilic group is a C2-C8 carbonyl-containing group, a good wetting effect is achieved between the cathode material and the ester electrolyte, and the electrochemical performance of the cathode material itself will not be damaged.

In the present invention, the chemical structure of the esterophilic group is expressed as formula I:

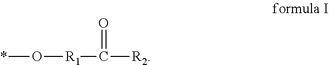

It is found that the length of the carbon chain in the esterophilic group will affect the difficulty and effect in connecting the esterophilic group to the carbon coating layer, and the longer the carbon chain, the more difficult it is to connect the esterophilic group to the carbon coating layer. Therefore, in formula I of the present invention, R₁ is selected from C1-C4 alkylene, and R₂ is selected from C1-C4 alkyl or amino group. Use of the above design can improve the wettability of the cathode material in the ester electrolyte to the greatest extent, and also can ensure the electrochemical performance of the cathode material itself without causing the cathode material to absorb excessive water. Moreover, it is more conducive to the introduction of the esterophilic group to the carbon coating layer.

As a specific embodiment, in the esterophilic group of the present invention, R₁ may be a methylene or ethylene, and/or, R₂ may be a methyl, ethyl or amino. Taking into account wettability, low water absorption, electrochemical performance and ease of introduction, R₁ and R₂ can be limited to other esterophilic groups that meet the described introduction conditions or can bring about the described effect. By selecting the above R₁ and R₂ groups, the corresponding esterophilic groups can better achieve the performance of the above aspects.

More specifically, the esterophilic group selected by the present invention is chemically bonded to the surface of the carbon coating layer in the form of a covalent bond. In other words, the esterophilic group is connected to the surface of the carbon coating layer by a chemical reaction, and the esterophilic substance and the carbon-coated cathode substrate form a whole material. In this way, the cathode material has a stable structure, a long service life and stable wetting effect.

Since the esterophilic group and the ester electrolyte solvent have similar polarity in structure, they have good compatibility and wettability. The weight ratio of the esterophilic group in the carbon coating layer affects the wetting effect of the esterophilic group in the ester solvent. For example, when the content of esterophilic group is 1-2.5%, good wettability is achieved.

In order to ensure the electrochemical performance of the cathode material, the effect of introducing the esterophilic group to the carbon coating layer subsequently and the influence on the wettability, the weight of the carbon coating layer in the cathode material of the present invention is 1-2% of the weight of the cathode active substrate.

The present invention mainly introduces the esterophilic group to the carbon coating layer to improve the wettability of the cathode material in the ester solvent, and the method is suitable for more cathode active substrates, such as lithium iron phosphate, lithium iron manganese phosphate, lithium iron nickel phosphate, nickel-cobalt manganese or nickel-cobalt aluminum materials, and may be also suitable for other cathode active substrates that can be carbon-coated.

According to another aspect of the present invention, further provided is a preparation method for the described cathode material, including the following steps: step S1 of obtaining a cathode active substrate; step S2 of modifying the cathode active substrate by carbon coating to obtain a carbon-coated cathode active substrate; and step S3 of performing surface modification on the carbon-coated cathode active substrate, and introducing an esterophilic group to the surface of the carbon coating layer to form the cathode material.

In order to improve the wettability of the cathode material lithium iron phosphate to the electrolyte, reduce the internal resistance of the lithium ion battery, and improve the energy efficiency of the battery, at the same time of performing carbon coating on the cathode active substrate, the present invention changes the surface energy of the carbon coating layer of the cathode active substrate by introducing the esterophilic carbonyl with close polarity to the electrolyte, thereby significantly improving the wettability of the cathode active material to the electrolyte. Moreover, the method does not change the bulk structure of the cathode active material, so the electrochemical performance of the cathode active material is also guaranteed. The cathode plate prepared by the present invention shows excellent electrolyte wettability, and the prepared battery shows low internal resistance, high energy efficiency and other characteristics.

As described above, in the present invention, when the esterophilic group introduced to the carbon coating layer of the cathode material is carbonyl, better wettability can be achieved between the cathode active material and the ester electrolyte solvent. The esterophilic group selected by the present invention is mainly derived from carbonyl in a haloketone or carbonyl in a haloamide. These two compounds are more suitable for being connected to the carbon coating layer and have good wetting effect to the ester solvent, and will not be adversely affected by other substances or environments during the modification process. The molecular structures of the two compounds are relatively stable in a modified system. For example, the two compounds will not decompose under the influence of a chemical environment.

The technical conception of the present invention for performing surface modification on the carbon-coated cathode active substrate is as follows: After the preparation of the carbon-coated cathode material, the carbon coating layer on the surface of the carbon-coated cathode material is first hydroxylated. Considering the instability of the cathode material such as lithium iron phosphate in an acidic system, the carbon coating layer is hydroxylated by an alkaline process. After the hydroxylation treatment, in order to successfully connect carbonyl to the surface of the carbon coating layer, a strong alkali substance such as NaH is used to remove H⁺ ions in —OH on the surface of the carbon coating layer, at which time the hydroxyl becomes C—O⁻ as a nucleophile to attack R₁ carbonium ions attached to the halogen atoms in the haloketone or haloamide. Then, the haloketone or haloamide will be dehalogenated and connected to the surface of the carbon coating material, thus successfully performing esterophilic modification on the carbon coating layer. The presence of the carbonyl on the carbon coating layer can effectively improve the wettability of the cathode material such as lithium iron phosphate to the ester electrolyte.

The technical conception of the present invention involves reaction processes expressed as:

(C)ₙ—(OH)ₙ+nNaH→(C)n—(O—Na)ₙ+nH₂ (1)

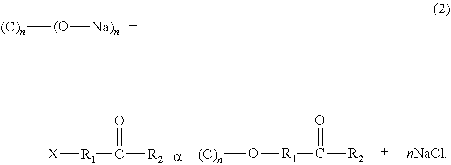

As a specific embodiment of the technical conception of the present invention, the process of performing surface modification on the carbon-coated cathode active substrate in the method of the present invention includes: step S3-1 of obtaining a surface-hydroxylated carbon-coated cathode active substrate; step S3-2 of mixing the surface-hydroxylated carbon-coated cathode active substrate, an alkali substance and a solvent in an inert atmosphere and allowing reaction with heating to obtain an intermediate; and step S3-3 of mixing the intermediate and a compound containing an esterophilic group in an inert atmosphere and allowing reaction with heating to obtain a carbon-covered cathode active substrate with the esterophilic group on the surface, i.e., the cathode material. The compound containing the esterophilic group is a haloketone or a haloamide. The haloketone has a structure represented by formula II:

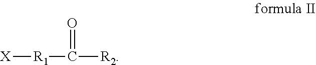

In formula II, R₁ is a C1-C4 alkylene, X is a halogen atom, and R₂ is a C1-C4 alkyl.

The present invention considers that the too long carbon chain of the esterophilic group selected in the surface modification process may increase the difficulty of the reaction, and the carbon chain length is appropriately limited to 2-8, for example, R₁ may be methylene, ethylidene, propylidene, butylene, and the like, and R₂ may be methyl, ethyl, propyl, butyl, and the like. From the perspective of raw material source, R₁ may be a methylene or an ethylene, R₂ is a methyl or an ethyl; X is a halogen atom, and may be selected from a chlorine atom, a bromine atom, and an iodine atom, especially from a chlorine atom and a bromine atom.

The haloamide has a structure represented by formula III:

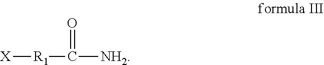

In formula III, R₁ is a C1-C4 alkylene and X is a halogen atom.

Similarly, considering that a too long carbon chain length of the esterophilic groups selected in the surface modification process may increase the difficulty of the reaction, the carbon chain length is appropriately limited to 2-8, for example, R₁ may be a methylene, an ethylidene, a propylidene, a butylene, or the like, and the original R₂ position is an amino. From the perspective of raw material source, R₁ may be a methylene or an ethylidene; X is a halogen atom, and may be selected from a chlorine atom, a bromine atom, and an iodine atom, especially from a chlorine atom and a bromine atom.

As a specific embodiment, in step S3-3, the haloketone is selected from one or more of chloroacetone, chlorobutanone, bromoacetone, bromobutanone, and iodoacetone, and in terms of the source of raw materials, chloracetone, chlorobutanone or bromoacetone may be selected; the haloamide is selected from chloroacetamide, 3-chloropropionamide or chloroprene amide, and in terms of the source of raw materials, chloroacetamide or 3-chloropropionamide may be selected.

In specific embodiments, for example, the following haloketones and haloamides are used:

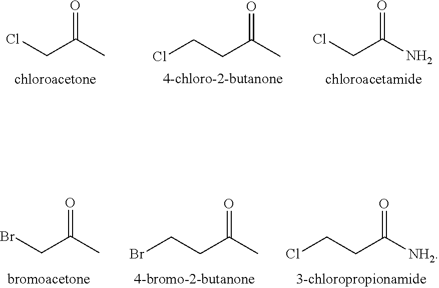

As a specific embodiment, in the process of “hydrogen removal” in step S3-2 of the present invention, in addition to sodium hydride (NaH), the used alkali substance (strong alkali) may also be selected from one or more of potassium hydride, lithium diisopropylamide and lithium bis(trimethylsilyl)amide that have similar functions. These strong alkali substances can be used to remove the H⁺ ions in the —OH on the carbon coating layer, at which time the hydroxyl becomes C—O as a nucleophile to attack R₁ carbonium ions attached to the halogen atoms in the haloketone or haloamide.

As a specific embodiment, the solvent used in step S3-2 is N,N-dimethylformamide, which is used for dissolving the strong alkali substance such as NaH to facilitate the reaction.

As a concrete embodiment, the hydrogen removal process in step S3-2 is performed under the protection of an inert atmosphere, such as argon.

As a specific embodiment, the weight ratio of the alkali substance to the surface-hydroxylated carbon-coated cathode active substrate is (0.05-0.2):1, such as 0.05:1, 0.1:1, 0.15:1, or 0.2:1. With the reaction ratio, the present invention can achieve the purpose of fully “removing hydrogen” without destroying the structure of the active material due to strong alkalinity. For example, when the alkali substance is excessive, the remaining alkali substance will remove the hydrogen on the haloketone after the reaction, resulting in side reactions.

As a specific embodiment, the reaction with heating in step S3-2 is performed at a temperature of 30-50° C., for 3.5-4.5 h. A medium or low temperature is enough for the reaction in the “hydrogen removal” process of the present invention, and the controllability of the reaction process is poor if the temperature is too high.

As a specific embodiment, in step S3-3, the haloketone is selected from one or more of chloroacetone, chlorobutanone, bromoacetone, bromobutanone, and iodoacetone, and in terms of the source of raw materials, chloracetone, chlorobutanone or bromoacetone may be selected.

As a specific embodiment, the weight ratio of the alkali substance to the surface-hydroxylated carbon-coated cathode active substrate to the compound containing the esterophilic group is (0.05-0.2):1:(0.4-0.6). For example, the weight ratio of the alkali substance to the surface-hydroxylated carbon-coated cathode active substrate is 0.05:1, 0.08:1, 0.1:1, 0.13:1, 0.15:1, or 0.2:1; the weight ratio of the surface-hydroxylated carbon-coated cathode active substrate to the compound containing the esterophilic group is 1:0.4, 1:0.45, 1:0.5, 1:0.55, or 1:0.6. When the esterophilic compound is excessive, the esterophilic group can be adequately introduced. The present invention expresses the ratio of the intermediate to the compound containing the esterophilic group in step S3-3 through the ratio of the alkali substance to the surface-hydroxylated carbon-coated cathode active substrate to the compound containing the esterophilic group. With this ratio, the esterophilic group and the intermediate (material after hydrogen removal) can be fully connected. The final cathode material can be obtained by hydrogen removal before connection of the esterophilic group.

As a specific embodiment, the reaction with heating in step S3-3 is performed at a temperature of 55° C.-65° C. for 10-18 h. By using the reaction temperature and time, the haloketone or haloamide can be effectively dehalogenated and connected to C—O, thus achieving the purpose of connecting the esterophilic group to the surface of the carbon material and completing surface modification. If the temperature is too high, the carbonyl will participate in the reaction, resulting in side reactions.

As a specific embodiment, in step S3-3, the product obtained after the reaction with heating is cooled to 20° C.-35° C and aged for 1-2 h, and after the reaction is stopped, a crude product is obtained and then filtered, washed with water and spray granulated in turn to obtain the carbon-coated cathode active substrate with the esterophilic group on the surface, i.e., the cathode material.

As a specific embodiment, in step S3-1, the surface-hydroxylated carbon-coated cathode active substrate may be synthesized or selected from the prior art. In synthesis, the process of preparing the surface-hydroxylated carbon-coated cathode active substrate includes: mixing the carbon-coated cathode active substrate with an alkali solution, and allowing reaction with heating to obtain the surface-hydroxylated carbon-coated cathode active substrate.

As a specific embodiment, the ratio of the carbon-coated cathode active substrate to the alkali solution is (20-30) g:100 mL, and the concentration of the alkali solution is 1.5-2.5 mol/L, where the alkali solution is selected from one or more of sodium hydroxide solution, potassium hydroxide solution and lithium hydroxide solution; the hydroxylation reaction with heating is performed at a temperature of 180° C.-220° C. for 5.5-6.5 h. By using the above ratio of raw materials, reaction temperature and reaction time, complete hydroxylation reaction is ensured without affecting the structure of the active material, and then the appropriate hydroxylated carbon-coated cathode active material can be obtained.

The cathode active substrate in step S1 of the present invention may be synthesized or commercially purchased, and its type is not limited, provided that its surface can be coated with a carbon coating layer.

As a specific embodiment, the process of modifying the cathode active substrate by carbon coating in step S2 of the present invention includes: mixing the cathode active substrate with a carbon source and performing calcination in an inert atmosphere such as argon to obtain the carbon-coated cathode active substrate. The carbon source for carbon coating modification may be selected from one or more of glucose, sucrose, citric acid, polystyrene and a biomass material. The weight ratio of the cathode active substrate to the carbon source is 1:(1-1.2); the calcination is performed at a temperature of 550° C.-650° C. for 5.5-6.5 h.

The cathode active substrate can be modified by carbon coating according to the above conditions, and the cathode active substrate may also be modified by carbon coating by other methods or a commercially purchased carbon-coating modified cathode active substrate may also be used.

Based on the cathode material developed by the present invention and having good wettability to an ester electrolyte, the present invention further provides a cathode plate, including a foil and a cathode slurry applied to a surface of the foil.

Based on the cathode plate developed by the present invention and having good wettability to an ester electrolyte, the present invention further provides a battery, including the cathode plate of the present invention, an anode plate, a separator and an electrolyte.

The cathode plate developed by the present invention has good wettability to an ester electrolyte, such as a carbonate solvent, and more specifically, such as one or more of dimethyl carbonate, vinyl carbonate, methyl ethyl carbonate, and diethyl carbonate.

The present application is described in further detail below in conjunction with specific embodiments, and these embodiments are not to be construed as limiting the scope claimed in the present application.

### Example 1

### (1) Preparation of Modified Material

1. One part of iron phosphate (a precursor of lithium iron phosphate) and 1.02 parts of a lithium source were weighed and mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder. The raw materials used were all calculated in parts by weight.

2. One part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

3. The obtained carbon-coated lithium iron phosphate cathode material was added to 2M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

4. An appropriate amount (0.05 parts) of strong alkali NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of chloracetone was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

A slurry was made from the lithium iron phosphate cathode material, a conductive agent, CNT, a binder and an NMP solvent at a ratio of 96.8:0.8:0.4:2:60.

The specific process was as follows: The lithium iron phosphate cathode material, the binder and the conductive agent were placed into a mixing tank at the above ratio and dry mixed and stirred for 30 min at a rotation speed of 15 rpm and a dispersion speed of 400 rpm to obtain a mixture. Then, 60% of the above NMP solvent was added to the mixture and a resulting mixture was kneaded and stirred for 40 min at a stirring rotation speed of 15 rpm and a dispersion speed of 400 rpm. Then, the remaining NMP solvent was added and the mixture was stirred for 60 min at a rotation speed of 22 rpm and a dispersion speed of 1000 rpm. Finally, the CNT was added at the above ratio and the mixture was stirred for 120 min at a rotation speed and a dispersion speed of 1000 rpm to obtain a cathode slurry.

The obtained cathode slurry was applied to a carbon-coated aluminum foil according to the requirements to obtain the cathode plate of Example 1.

The raw materials of anode slurry were weighed in parts: 96 parts of graphite powder (anode active substance), 0.8 parts of SP (conductive agent), 2 parts of SBR (binder), 1.2 parts of CMC (dispersant), and 90 parts of deionized water.

The graphite powder, the conductive agent and the dispersant were placed in the above amount in the mixing tank and dry mixed for 30 min at a stirring rotation speed of 15 rpm and a dispersion speed of 500 rpm. Then, 50 parts of deionized water was added and the mixture was then kneaded and stirred for 60 min at a stirring rotation speed of 20 rpm and a dispersion speed of 300 rpm. Then, the remaining deionized water was added for high-speed dispersion, where the stirring rotation speed was 22 rpm, and the dispersion speed was 1000 rpm. Finally, the binder was added and the mixture was then stirred for 30 min at a stirring rotation speed of 22 rpm and a dispersion speed of 500 rpm to finally obtain the anode slurry. The prepared anode slurry was applied to a copper foil to obtain an anode plate.

(3) The cathode plate and the anode plate obtained in Example 1 were assembled by a laminating process to obtain a soft-pack cell. A separator used for assembly was a coated PP separator with a thickness of 7+2+2. The amount of electrolyte used in a single cell is 10 g, the specific ratio of DMC to EC in the electrolyte was 1:1, the solubility of lithium salt LiPF6 was 1 mol/L, and the nominal capacity of the soft pack cell obtained was 2.3 Ah.

### Example 2

### (1) Preparation of Modified Material

S1: one part of iron phosphate (a precursor of lithium iron phosphate) and 1.02 parts of a lithium source were weighed and mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder. The raw materials used were all calculated in parts by weight.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S4: an appropriate amount (0.1 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4h and then heated up to 60° C., an appropriate amount (0.5 parts) of chloracetone was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

According to the specific requirements, the cathode plate and anode plate of Example 2 were prepared by the electrode plate preparation method and process of Example 1.

(3) The cathode plate and anode plate obtained in Example 2 were assembled into a soft-pack cell according to the method of Example 1, and the nominal capacity of the soft-pack cell obtained was 2.3 Ah.

### Example 3

### (1) Preparation of Modified Material

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2 M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S3: an appropriate amount (0.15 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of chloracetone was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

According to the specific requirements, the cathode plate and anode plate of Example 3 were prepared by the electrode plate preparation method and process of Example 1.

(3) The cathode plate and anode plate obtained in Example 3 were assembled into a soft-pack cell according to the method of Example 1, and the nominal capacity of the soft-pack cell obtained was 2.3 Ah.

### Example 4

### (1) Preparation of Modified Material

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6h in an Ar atmosphere, thus obtaining a carbon-coated lithium iron phosphate cathode material.

S3: the obtained carbon-coated lithium iron phosphate cathode material was added to 2M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S4: an appropriate amount (0.2 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of chloracetone was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

(2) Preparation of electrode plates

According to the specific requirements, the cathode plate and anode plate of Example 4 were prepared by the electrode plate preparation method and process of Example 1.

(3) The cathode plate and anode plate obtained in Example 4 were assembled into a soft-pack cell according to the method of Example 1, and the nominal capacity of the soft-pack cell obtained was 2.3 Ah.

### Example 5

### (1) Preparation of Modified Material

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2 M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S4: an appropriate amount (0.15 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of 4-chloro-2-butanone was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

According to the specific requirements, the cathode plate and anode plate of Example 5 were prepared by the electrode plate preparation method and process of Example 1.

(3) The cathode plate and anode plate obtained in Example 5 were assembled into a soft-pack cell according to the method of Example 1, and the nominal capacity of the soft-pack cell obtained was 2.3 Ah.

### Example 6

### (1) Preparation of Modified Material

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S4: an appropriate amount (0.15 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of bromoacetone was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

According to the specific requirements, the cathode plate and anode plate of Example 6 were prepared by the electrode plate preparation method and process of Example 1.

(3) The cathode plate and anode plate obtained in Example 6 were assembled into a soft-pack cell according to the method of Example 1, and the nominal capacity of the soft-pack cell obtained was 2.3 Ah.

### Example 7

### (1) Preparation of Modified Material

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2 M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S4: an appropriate amount (-0.15 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of 4-bromo-2-butanone was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

According to the specific requirements, the cathode plate and anode plate of Example 7 were prepared by the electrode plate preparation method and process of Example 1.

(3) The cathode plate and anode plate obtained in Example 7 were assembled into a soft-pack cell according to the method of Example 1, and the nominal capacity of the soft-pack cell obtained was 2.3 Ah.

### Example 8

### (1) Preparation of Modified Material

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2 M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S4: an appropriate amount (0.05-0.15 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of chloroacetamide was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

According to the specific requirements, the cathode plate and anode plate of Example 8 were prepared by the electrode plate preparation method and process of Example 1.

(3) The cathode plate and anode plate obtained in Example 8 were assembled into a soft-pack cell according to the method of Example 1, and the nominal capacity of the soft-pack cell obtained was 2.3 Ah.

### Example 9

### (1) Preparation of Material

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

S4: an appropriate amount (0.05-0.15 parts) of NaH was dissolved with stirring into DMF in an Ar atmosphere, an appropriate amount (1 part) of the hydroxylated carbon-coated lithium iron phosphate powder was then added, a resulting mixed solution was then stirred to react at 40° C. for 4 h and then heated up to 60° C., an appropriate amount (0.5 parts) of 3-chloropropanamide was then added to react for 12 h, and the reaction solution was then cooled to room temperature and aged for 1 h. After the reaction was stopped, a reaction product was filtered and washed repeatedly with deionized water and anhydrous ethanol. Finally, spray granulation was performed to obtain a carbon-coated lithium iron phosphate cathode material with carbonyls on the surface.

### (2) Preparation of Electrode Plates

According to the specific requirements, the cathode plate and anode plate of Example 8 were prepared by the electrode plate preparation method and process of Example 1.

(3) The cathode plate and anode plate obtained in Example 9 were assembled into a soft-pack cell according to the method of Example 1, and the nominal capacity of the soft-pack cell obtained was 2.3 Ah.

### Comparative Example 1 (Carbon Coating Modification)

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

### (2) Preparation of Electrode Plates

According to the specific requirements, the cathode plate and anode plate of Comparative Example 1 were prepared by the electrode plate preparation method and process of Example 1.

(3) The cathode plate and anode plate obtained in Comparative Example 1 were assembled into a soft-pack cell according to the method of Example 1, and the nominal capacity of the soft-pack cell obtained was 2.3 Ah.

### Comparative Example 2 (Carbonyl Modification)

S1: one part of iron phosphate (a precursor of lithium iron phosphate) and 1.02 parts of a lithium source were mixed with an appropriate amount (2-3 parts) of anhydrous ethanol, and a resulting mixture was ball-milled at 500 rpm for 12 h to obtain a mixed slurry with a particle size of 300-1000 nm. The mixed slurry was then spray granulated to obtain powder. The powder was calcined at 650° C. in a tube furnace for 24 h in an Ar atmosphere, thus obtaining a lithium iron phosphate powder.

S2: one part of the lithium iron phosphate powder and 1.1 parts of glucose were mixed with an appropriate amount (2-3 parts) of anhydrous ethanol, and a resulting mixture was ball-milled at 500 rpm for 4 h. After spray granulation, a resulting powder was calcined at 700° C. in a tube furnace for 6 h in an Ar atmosphere, thus obtaining a carbon-coated lithium iron phosphate cathode material.

S3: the obtained carbon-coated lithium iron phosphate cathode material was added to 2M NaOH aqueous solution, a resulting solution was fully stirred and then transferred to a reactor to react at 200° C. for 6 h. After the reaction, the reaction solution was cooled to room temperature, filtered, and washed with deionized water and anhydrous ethanol. Finally, spray granulation was performed to obtain surface-hydroxylated carbon-coated lithium iron phosphate.

### (2) Preparation of Electrode Plates

According to the specific requirements, the cathode plate and anode plate of Comparative Example 1 were prepared by the electrode plate preparation method and process of Example 2.

(3) The cathode plate and anode plate obtained in Comparative Example 2 were assembled into a soft-pack cell according to the method of Example 1, and the nominal capacity of the soft-pack cell obtained was 2.3 Ah.

Wettability tested for electrode plates prepared in Examples 1 to 9 and Comparative Examples 1 to 2:

An electrode plate with the size of 20 cm in length and 10 cm in width was taken. One width side of the electrode plate was fixed with a fixture and connected to a weighing gauge and then fixed to a support. The other width side of the electrode plate was immersed into the electrolyte at a height of 1 cm. The weighing gauge was zeroed before immersion. After the electrode plate was immersed in the electrolyte, the change of the indicator number on the weighing gauge with time was recorded, thus obtaining the wettability of each electrode plate in the electrolyte.

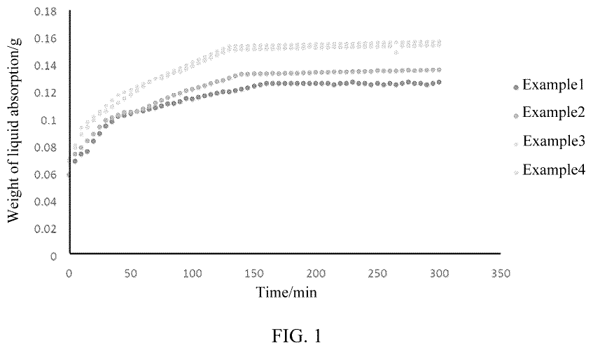

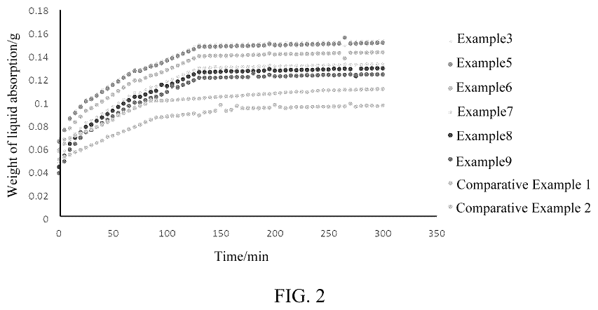

The cathode plates of the cathode material prepared under various experimental conditions were tested for their liquid absorption. FIG. 1 shows the liquid absorption curves of cathode materials prepared with different strong alkali ratios in the examples. FIG. 2 shows the liquid absorption curves of cathode materials prepared by using different halides.

As shown in FIG. 1, the cathode materials were prepared by changing the strong alkali ratio in the carbonylation reaction (Experimental Examples 1to 4). With the increase of the strong alkali ratio, the liquid absorption of the electrode plates of the prepared cathode materials gradually increased, indicating that the wettability of the cathode materials to the electrolyte increased. When the amount of strong alkali used was increased to 0.15 parts, the liquid absorption of the cathode plate would no longer increase after the strong alkali ratio was increased. This is because for the reaction (1), the strong alkali is excessive, and all the —OH on the carbon surface has reacted, that is, when the weight ratio of the alkali substance to the surface-hydroxylated carbon-coated cathode active substrate is 0.05:1 or above, the wettability has already met the requirements, and everything considered, the preferred ratio range is (0.1-0.2):1. With this ratio, complete reaction can be ensured without damaging the material structure or wasting raw materials.

As shown in FIG. 2, Experimental Examples 3, 5, 6 and 7 used different haloketones as reactants to modify the surface of carbon-coated materials. It can be seen from the experimental results that the wettability of the lithium iron phosphate materials modified by chloracetone, 4-chloro-2-butanone, bromoacetone and 4-bromo-2-butanone in the examples of the present invention is significantly improved as compared with the wettability of materials prepared in Comparative Examples 1 and 2 without modification with haloketones. It indicates that using only the carbon coating modification of Comparative Example 1 and the carbonyl-modification carbon coating of Comparative Example 2 has no obvious effect in improving the wettability of cathode plates, while the present invention significantly improves the wettability of the cathode active material in the ester solvent by introducing the esterophilic group to the carbon coating layer.

As shown in FIG. 2, the present invention improves the wettability of the cathode materials after modification with haloketones. The curves show that the wetting effect of the chloropone-modified material is slightly better than that of the 4-chloro-2-butanone-modified material, and the wetting effect of the bromoacetone-modified material is slightly better than that of the 4-bromo-2-butanone-modified material. The reason is that as the carbon chain increases, the electronegativity of the carbon atom connected by the halogen decreases, thus increasing the difficulty of the reaction (2) (C)n—(ONa)n+(X—CnH₂ₙ₋₁O)n→(C)n—(O—CnH₂ₙ₋₁O)n+nNaCl. In the meanwhile, with the same carbon chain length, the wettability of the materials modified by chloroketones to the electrolyte is relatively better than that of the materials modified by bromoketones. The reason is that the chlorine atom is more no nmetallic than the bromine atom, resulting in stronger electronegativity of the connected carbon atom and easier implementation of reaction (2).

For the cathode materials modified by haloamides (Examples 8 and Examples 9), their wettability trend is the same as that of the cathode materials modified by haloketones, and the wetting effect of the material modified by chloroacetamide is slightly better than that of the material modified by 3-chloropropionamide. However, the wetting effect of the materials modified by haloamides is slightly worse than that of the materials modified by haloketones. This is because compared with the carbonyl, the amide group has a large polarity, and the polarity difference between the amide group and the electrolyte is greater than that between the carbonyl and the electrolyte, resulting in lower wettability. Even so, the wettability of the modified cathode materials of Examples 8 and 9 in the ester electrolyte is still significantly better than that of Comparative Examples 1 and 2. Examples 8 and 9 of the present invention adopt haloamides, such as chloroacetamide, chloropropionamide, chlorbutyamide, to modify carbon-coated lithium iron phosphate materials with good wettability in the ester electrolyte.

Referring to the examples and comparative examples in FIG. 2, it is indicated that the wettability of the carbon-coated cathode materials modified by haloketones and haloamides is significantly improved as compared with the wettability of the cathode materials not modified by haloketones and haloamides in the comparative examples.

Test for electrical properties of soft-pack cells in Examples 1 to 9 and Comparative Examples 1 to 2:

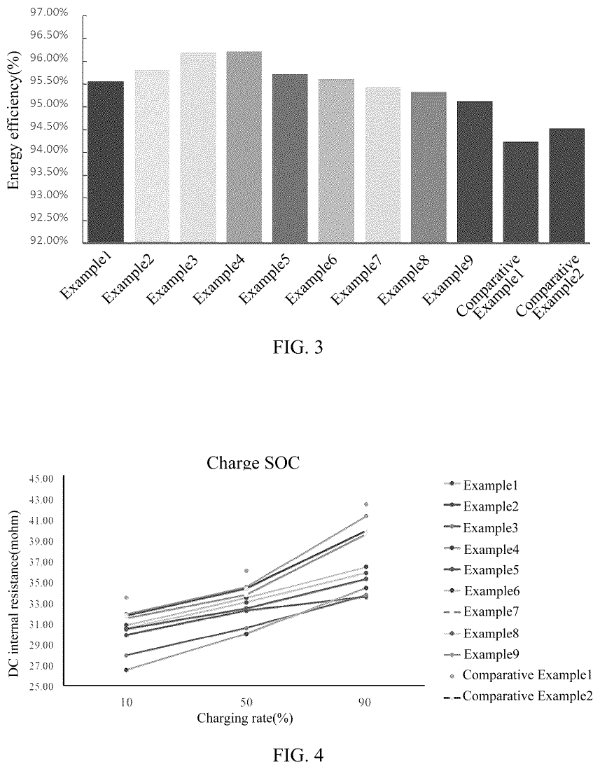

(1) At 25° C., the cells prepared in the examples were charged and discharged at the power of 0.5 P, and the time interval between charge and discharge is 10 min. The charge and discharge capacity and energy of the cells in the examples were recorded and the energy efficiency was calculated. The results are shown in Table 1 and FIG. 3.

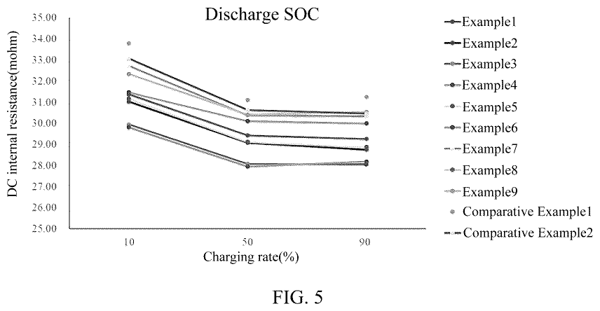

(2) At 25° C., the cells were charged to 10% SOC, 50% SOC, 90% SOC, and then charged and discharged for 10 s in sequence with 2 C current. The DCR internal resistance of the cells was then calculated under different SoCs in different examples. The results are shown in FIGS. 4 and 5.

TABLE 1

| | Charge | Discharge | Charge | Discharge | |
|---|---|---|---|---|---|
| | capacity | capacity | energy | energy | Energy |
| Group | (Ah) | (Ah) | (Wh) | (Wh) | efficiency |
| Example 1 | 2.389 | 2.397 | 8.058 | 7.699 | 95.55% |
| Example 2 | 2.365 | 2.369 | 7.992 | 7.660 | 95.85% |
| Example 3 | 2.391 | 2.400 | 8.085 | 7.778 | 96.20% |
| Example 4 | 2.370 | 2.377 | 7.998 | 7.696 | 96.23% |
| Example 5 | 2.386 | 2.395 | 8.042 | 7.698 | 95.72% |
| Example 6 | 2.375 | 2.383 | 8.005 | 7.654 | 95.62% |
| Example 7 | 2.36 | 2.37 | 7.965 | 7.603 | 95.45% |
| Example 8 | 2.16 | 2.16 | 7.693 | 7.334 | 95.33% |
| Example 9 | 2.37 | 2.38 | 7.994 | 7.604 | 95.12% |
| Comparative | 2.44 | 2.44 | 8.231 | 7.756 | 94.24% |
| Example 1 | | | | | |
| Comparative | 2.44 | 2.44 | 8.238 | 7.787 | 94.52% |
| Example 2 | | | | | |

It can be seen from the experimental results that the electrical properties of the surface-modified carbon-coated cathode material are not affected, and the energy efficiency results of the soft-coated cells obtained in different examples (Table 1 and FIG. 3) are consistent with the obtained wettability results of electrode plates. The better the wettability of the electrode plates, the higher the energy efficiency of the cells. The excellent wettability can reduce the internal resistance of the cells (as verified by the results of FIG. 4 and FIG. 5) and the heating during the charging and discharging process, thereby improving the energy utilization rate. The improvement of electrode wettability has a significant effect in improving the performance of the cell. It should be noted that the terms “first”, “second”, etc. in the specification and claims of the present application are used to distinguish similar objects and are not necessarily used to describe a particular order or sequence. It should be understood that the terms so used are interchangeable where appropriate so that the embodiments of the present application described herein can, for example, be implemented in an order other than those described herein.

The above are only preferred embodiments of the invention and are not intended to limit the invention. For those skilled in the art, the embodiments of the invention may have various modifications and changes. Any modification, equivalent replacement, improvement, etc. made within the spirit and principle of the invention shall fall within the scope of the disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A cathode material, comprising a cathode active substrate, wherein a surface of the cathode active substrate is coated with a carbon coating layer;
wherein a surface of the carbon coating layer has an esterophilic group, the esterophilic group is a C2-C8 carbonyl-containing group, and the esterophilic group has a structure of formula I: 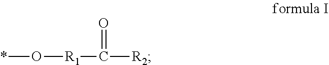
wherein R₁ is a C1-C4 alkylene, and R₂ is a C1-C4 alkyl or amino group; the esterophilic group is chemically bonded to the surface of the carbon coating layer via a covalent bond.

2. The cathode material according to claim 1, wherein the carbon coating layer comprises 1% to 2.5% by weight of the esterophilic group.

3. The cathode material according to claim 1, wherein the cathode active substrate comprises 1% to 2% by weight of the carbon coating layer.

4. The cathode material according to claim 1, wherein the cathode active substrate comprises lithium iron phosphate, lithium manganese iron phosphate, lithium nickel iron phosphate, nickel cobalt manganese or nickel cobalt aluminum.

5. The cathode material according to claim 1, wherein the cathode material is prepared by a method comprising:
step S1: obtaining a cathode active substrate;
step S2: modifying the cathode active substrate by carbon coating to obtain a carbon-coated cathode active substrate; and
step S3: performing surface modification on the carbon-coated cathode active substrate, and introducing an esterophilic group to the surface of the carbon coating layer to form the cathode material.

6. The cathode material according to claim 5, wherein the esterophilic group in step S3 is derived from a carbonyl in a haloketone or a carbonyl in a haloamide.

7. The cathode material according to claim 5, wherein the performing surface modification on the carbon-coated cathode active substrate in step S3 comprises:
step S3-1: mixing the carbon-coated cathode active substrate with an alkali solution, and subjecting to heating for reaction to obtain a surface-hydroxylated carbon-coated cathode active substrate;
step S3-2: mixing the surface-hydroxylated carbon-coated cathode active substrate, an alkali substance and a solvent in an inert atmosphere and subjecting to heating for reaction to obtain an intermediate; and
step S3-3: mixing the intermediate and a compound containing the esterophilic group in an inert atmosphere and subjecting to heating for reaction to obtain a carbon-covered cathode active substrate having the esterophilic group on the surface, i.e., the cathode material;
wherein the compound containing the esterophilic group is a haloketone or a haloamide;
the haloketone has a structure of formula II: 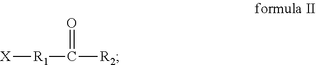
wherein, R₁ is a C1-C4 alkylene, X is a halogen atom, and R₂ is a C1-C4 alkyl;
the haloamide has a structure of formula III: 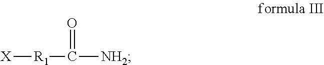
wherein, R₁ is a C1-C4 alkylene and X is a halogen atom.

8. The cathode material according to claim 6, wherein in step S3-2, the alkali substance comprises one or more of sodium hydride, potassium hydride, lithium diisopropylamide and lithium bis(trimethylsilyl)amide.

9. The cathode material according to claim 6, wherein the solvent comprises N,N-dimethylformamide.

10. The cathode material according to claim 6, wherein the inert atmosphere comprises argon atmosphere.

11. The cathode material according to claim 6, wherein a weight ratio of the alkali substance to the surface-hydroxylated carbon-coated cathode active substrate is (0.05 to 0.2):1.

12. The cathode material according to claim 6, wherein the heating in step S3-2 is performed at a temperature of 30 to 50° C. for 3.5 to 4.5 h.

13. The cathode material according to claim 6, wherein in step S3-3, the haloketone is selected from one or more of chloroacetone, chlorobutanone, bromoacetone, bromobutanone, and iodoacetone.

14. The cathode material according to claim 6, wherein in step S3-3, the haloamide is selected from one or more of chloroacetamide, 3-chloropropionamide, and chlorobutyramide.

15. The cathode material according to claim 6, wherein a weight ratio of the alkali substance, the surface-hydroxylated carbon-coated cathode active substrate and the compound containing the esterophilic group is (0.05 to 0.2):1:(0.4 to 0.6).

16. The cathode material according to claim 6, wherein the heating in step S3-3 is performed at a temperature of 55° C. to 65° C. for 10 to 18 h; and/or
in step S3-3, the product obtained after the heating is cooled to 20° C. to 35° C. and aged for 1 to 2 h to obtain a crude product, and the crude product is then sequentially subjected to filtering, water washing and spray granulation to obtain the carbon-coated cathode active substrate having the esterophilic group on its surface, i.e., the cathode material.

17. The cathode material according to claim 6, wherein a ratio of the carbon-coated cathode active substrate to the alkali solution is (20 to 30) g: 100 mL, and the alkali solution has a concentration of 1.5 to 2.5 mol/L; and/or
in step S3-1, the alkali solution is selected from one or more of sodium hydroxide solution, potassium hydroxide solution, and lithium hydroxide solution; and/or, the heating in step S3-1 is performed at a temperature of 180° C. to 220° C. for 5.5 to 6.5 h.

18. The cathode material according to claim 5, wherein in step S1, the cathode active substrate comprises lithium iron phosphate, lithium manganese iron phosphate, lithium nickel iron phosphate, nickel-cobalt manganese, or nickel-cobalt aluminum; and/or,
a carbon source for carbon coating modification in step S2 comprises one or more of glucose, sucrose, citric acid, polystyrene and a biomass material; and/or
the modifying the cathode active substrate by carbon coating in step S2 comprises: mixing the cathode active substrate and the carbon source and performing calcination in an inert atmosphere to obtain the carbon-coated cathode active substrate,
wherein:
a weight ratio of the cathode active substrate to the carbon source is 1:(1 to 1.2);
the inert atmosphere comprises argon atmosphere; and
the calcination is performed at a temperature of 550° C. to 650° C. for 5.5 to 6.5 h.

19. The cathode material according to claim 5, wherein the cathode material is adapted to prepare a battery, wherein the battery comprises a cathode plate, an anode plate, a separator and an electrolyte, wherein
the cathode plate comprises a foil and a cathode slurry applied to a surface of the foil, the cathode slurry comprises the cathode material.

20. The cathode material according to claim 19, wherein the electrolyte comprises an ester solvent, the ester solvent comprises a carbonate solvent, and the ester solvent is selected from one or more of dimethyl carbonate, vinyl carbonate, methyl ethyl carbonate, and diethyl carbonate.
